(19) United States
(12) Patent Application Publication
(10) Pub. No.: US 2015/0208606 A1
(43) Pub. Date: Jul. 30, 2015

(54) ODOUR CONTROLLER

(71) Applicant: THE ALL NATURAL PET LITTER COMPANY PTY LTD, VIC (AU)

(72) Inventors: Graeme Raper, Vic (AU); Louis Raper, Vic (AU)

(73) Assignee: THE ALL NATURAL PET LITTER COMPANY PTY LTD, VIC (AU)

(21) Appl. No.: 14/424,677

(22) PCT Filed: Aug. 27, 2013
(86) PCT No.: PCT/AU2013/000953

§ 371 Date: Feb. 27, 2015

(30) Foreign Application Priority Data
Aug. 27, 2012 (AU) 2012903688

(51) Int. Cl. A01K 1/015

(52) U.S. Cl. CPC A01K 1/0155; A01K 1/0154

(57) ABSTRACT

The present invention provides an odour controller comprising at least one absorbent mineral material and a microbiota that facilitates malodour-control. Preferably, the absorbent mineral material is expanded perlite and/or exfoliated vermiculite.

### FIELD OF THE INVENTION

The present invention relates to an absorbent mineral material that has been treated with microbiota that facilitates malodour-control. In particular, it relates to particles useful as animal litter and/or animal bedding and having effective malodour-inhibiting properties.

### BACKGROUND TO THE INVENTION

Clay has long been used as a liquid absorbent, and has found particular usefulness as an animal litter. However, clay has very poor malodour-controlling qualities, and in the process of using it, the inevitable build-up of waste leads to the production of severe malodour. There have been many attempts to produce animal litters that are both absorbent and malodour-controlling. One attempted solution to the problem of odour control has been the introduction of granular activated carbon into the litter, such as that described in U.S. Pat. No. 5,860,391 to Maxwell et al. Other means of reducing malodours include the inclusion of baking soda and/or pleasantly odourised crystals in the litter.

Other litters that provide some malodour control include biodegradable litters made from various plant resources, including pine wood pellets, recycled newspaper, clumping sawdust, barley and dried orange peel.

Another class of materials used as litter is silica gel, often referred to as “crystal litter”. This is a porous granular form of sodium silicate. It has the highest absorbency of all currently used litters and has excellent moisture control, as well as providing good malodour elimination for an extended period of time compared to other litters.

The human objection to malodour is not the only reason why it is desirable to reduce it. Studies have shown that cats prefer to use litter having little or no smell. One theory is that cats like to mark their territory by urinating in it. If cats return to their litterbox and they cannot sense their own odour, they will try to mark their territory again. The nett effect of this is that cats return to use the litter box more often if the odour of their markings is reduced. That is, the length of time before the litter needs changing can be increased if the malodour can be reduced. What is needed is an absorbent material having improved malodour-controlling properties, and one that maintains such properties for longer periods of time.

### SUMMARY OF THE INVENTION

The present invention provides an odour-controller comprising at least one absorbent mineral material and a microbiota which facilitates malodour-control. Preferably, the absorbent mineral material is expanded perlite, exfoliated vermiculite, or a mixture thereof, and the microbiota comprises a probiotic formulation. Preferably, the probiotic formulation comprises: i) non-pathogenic, heterotrophic microorganisms; and/or non-pathogenic, autotrophic microorganisms. More preferably, the microorganisms are non-genetically modified microorganisms.

The present invention also provides a method for producing an odour-controller, the method including the steps of: i) heating an industrial mineral to produce an absorbent mineral material; and then ii) applying a microbiota which facilitates malodour-control to the absorbent mineral material, whereby the absorbent mineral material in combination with the microbiota comprise the odour-controller. Preferably, the industrial mineral material is perlite, vermiculite or a mixture thereof, whereby the absorbent mineral material is expanded perlite and/or exfoliated vermiculite, respectively. Preferably, the probiotic formulation comprises non-pathogenic, heterotrophic microorganisms. More preferably, the microorganisms are non-genetically modified microorganisms.

The odour-controller of the present invention may find particular use as an animal litter, as discussed in detail below. Accordingly, the present invention provides an odour-control animal litter. The odour controller may also be used in other applications, such as bedding for small animals or in refuse containers or garbage bins.

### BRIEF DESCRIPTION OF THE DRAWINGS

FIG. 1 shows the number of viable bacteria for different probiotics and applications, as explained in the Examples.

### DETAILED DESCRIPTION OF THE INVENTION

The following description refers to specific embodiments of the present invention and is in no way intended to limit the scope of the present invention to those specific embodiments.

In one preferred form of the present invention, the odour controller in employed as an animal litter which finds use as a litter for a large number of different domestic and/or commercially relevant animals including, but not limited to, cats, dogs, rabbits, ferrets and guinea pigs. The following description is therefore directed primarily to this application and it is to be understood that the term “litter”, as used throughout, is a reference to the material that is generally used for such animals to urinate and/or defecate onto or into. It is also to be understood that animal litter may also be used in bedding areas for many animals as, for example, an absorbent material onto which animals either urinate or defecate.

The absorbent mineral material upon which the present invention is based is preferably selected from expanded perlite and/or exfoliated vermiculite. Perlite is an industrial mineral and is a generic term used to describe naturally occurring siliceous rock. A distinguishing feature, which sets perlite apart from other volcanic, glasses, is that when heated to a suitable point in its softening range, it expands from about four to about twenty times its original volume. This expansion is due to the presence of two to six percent water (by weight) in the crude perlite ore which, when quickly heated to above 800° C., vaporizes. This causes the perlite ore to pop in a manner similar to popcorn which results in the creation of a matrix of pores in the expanded perlite.

Expanded perlite is typically characterised by its porous-like particle structure, having voids therein which may be filled with liquid or water if such is made available to the particle. The retention capacity of expanded perlite varies depending on particle size. Generally, however, perlite can hold approximately 300-400% of its own weight in moisture or liquids, which is very similar to vermiculite particles.

Expanded perlite is typically graded according to its specific particle size. For example: Superfine material has a size of 0.5-2.0 mm; Fine material has a size of 1.0-3.0 mm; Medium material has a size of 2.0-4.0 mm; Coarse material has a size of 3.0-6.0 mm; and Super Coarse material has a size of 6.0-12.0 mm. Finer grades of perlite can also be manufactured such as: 0.20-0.40 mm, 0.40-0.60 mm; and 0.60-0.80 mm. However, in order to achieve such particle size control, the perlite ore must either be crushed prior to expansion or the expanded perlite must be crushed post-expansion. It is to be understood that all grades and/or sizes of perlite are equally encompassed by the present disclosure.

Vermiculite is also an industrial mineral and is a naturally occurring material. It has a typical chemical formula of: (Mg, Ca, K, Fe^{II})₃(Si, Al, Fe^{III})₄O₁₀(OH)₂•4H₂O. Table 1 below shows a typical chemical analysis of vermiculite and perlite, respectively.

TABLE 1
Chemical Analysis of Vermiculite and Perlite (wt %)

| Component | Vermiculite | Perlite |
|---|---|---|
| Silica (SiO₂) | 38-46% | 70-75% |
| Alumina (Al₂O₃) | 10-16% | 12-15% |
| Potash (K₂O) | 1-6% | 3-5% |
| Iron Oxide (Fe₂O₃) | 6-13% | 0.5-2% |
| Lime (CaO) | 1-5% | 0.5-1.5% |
| Magnesia (MgO) | 16-35% | 0.2-0.7% |
| Titania (TiO₂) | 1-3% | — |
| Water (H₂O) | 8-16% | 2-6% |

Vermiculite is characterised by having layers of silicate lattice structures in which the silicate layer units have a thickness of approximately 1 nm. As noted above, the main elements present in the layers are magnesium, aluminium, silicon and oxygen. The layers are separated by one or two sheets of water molecules associated with cations, such as magnesium, calcium, sodium and hydrogen, the layers being of considerable lateral extent relative to their thickness of 1 nm.

Vermiculite is another industrial mineral that expands when heated, the expansion process being termed exfoliation. Typically, the vermiculite ore is heated to a temperature of 600-750° C., at which point, water trapped between the layers vaporizes thereby causing the ore to expand or “exfoliate”. Since the ore is substantially horizontally arranged or layered, exfoliation results in elongated vermiculite, which resembles worms. The resultant exfoliated vermiculite is porous due to the separation of the layers during exfoliation.

Exfoliated vermiculite is frequently graded according to its particle size. For example, Grade 1 material has a size of 0-1 mm, Grade 2 material has a size of 2-5 mm,

Grade 3 material has a size of 3-8 mm, and Grade 4 material has a size of 6-18 mm. The Grade 4 material is the largest and generally has liquid-holding capacity, of approximately 400% by volume. It is to be understood that all grades and/or sizes of vermiculite are equally encompassed by the present disclosure.

Animal litters typically include absorbent materials, for example, clays such as bentonite and calcined clays, which are safe and non-irritating to the animals. Clays generally absorb relatively substantial amounts of liquids. Other litter-suitable, porous, absorbent materials, that may be used alone or in combination, include straw, sawdust, wood chips, wood shavings, porous polymeric beads, shredded paper, bark, cloth, ground corn husks, cellulose, water-insoluble inorganic salts, such as calcium sulphate, and sand. All of the above-mentioned absorbent materials are capable of absorbing and retaining liquid within their porous matrices, or, in the case of sand, absorbing liquid onto its surface. It is within the scope of the present invention to include additional absorbent materials such as those described above in order to provide additional absorptive properties to the animal litter of the present invention. Accordingly, it is to be understood that an animal litter of the present invention is to be predominantly composed of exfoliated vermiculite and/or expanded perlite, but may include additional absorbent materials such as those described above.

It is the porosity of exfoliated vermiculite and expanded perlite which makes these materials suitable to use as animal litter, since any applied liquid will be absorbed into the pores and voids of the solid material. For example, exfoliated vermiculite includes voids between the layers thereof which can accommodate liquid. While the following discussion refers predominantly to vermiculite, it applies equally to perlite.

In some embodiments of the present invention, the absorbent mineral material may be formed into agglomerates or pellets. Formation into pellets may involve the use of pressure and/or an adhesive. The nature of the absorbent mineral material is such that the application of only moderate pressure is required before the material begins to collapse and lose its ability to absorb liquid. It is therefore envisaged that an adhesive, such as a glue or a starch, may be used. Exemplary adhesives include, but are not limited to, bentonite, lime, gum arabic and carrageenan. The skilled person will appreciate that the main function of the adhesive is simply to adhere a small number of particles together to form agglomerates or pellets. In some embodiments of the present invention, the particles of the absorbent mineral material may be adhered together by using a starch. In a typical embodiment, a food starch may be used. Starch is a carbohydrate consisting of a large number of glucose units joined by glycosidic bonds such as in linear and helical amylose and in branched amylopectin.

Pelletising of the absorbent mineral material is typically carried out after expansion/exfoliation by mixing and/or agitating together the absorbent mineral material with an adhesive solution and drying the resultant pellets/agglomerates. In addition, further litter materials may by combined with the absorbent mineral material during the mixing with the adhesive solution. These further litter materials may include clay or sawdust, or any other absorbent material that is typically found in animal litters. In some embodiments of the present invention, the pellets may be formed by extruding or agglomerating the absorbent material(s) and adhesive solution mixture.

In yet further embodiments of the present invention, the odour controller, in the form of an odour-control animal litter may further include a clumping agent whereby, upon wetting, the absorbent mineral material, or pellets thereof, clump together to facilitate their removal from a litter tray. The skilled person will be aware of the use of such agents in currently available animal litters and can identify suitable agents for use with the vermiculite/perlite based odour control animal litter of the present invention.

While absorption of liquid makes the litter more pleasant for the animal to use, it does not necessarily significantly reduce or eradicate malodours emanating from the litter. Accordingly, the present invention also provides an odour-control animal litter comprising, at least one absorbent mineral material that has been further treated with microbiota. As noted above, the absorbent mineral material is preferably selected from expanded perlite and exfoliated vermiculite. In some embodiments, the absorbent mineral material may comprise one or both of expanded perlite and exfoliated vermiculite. Most preferably, the absorbent material is exfoliated vermiculite. Preferably, the microbiota used to treat the absorbent mineral material is a probiotic formulation. In particular, the Applicant has found that the use of a sufficient amount of a probiotic formulation in combination with an absorbent mineral material provides effective malodour control.

The microbiota of the litter of the present invention includes industrial microorganisms. The term “microbiota”, as used herein, includes all microorganisms added to the lifter. In preferred embodiments, the microbiota includes “probiotic” microorganisms. The term “probiotic” is typically used in relation to “beneficial” microorganisms that are used as dietary supplements for humans. Such probiotic organisms are generally used to modify the intestinal flora of the user and are essentially a culture of live and/or dormant bacteria and/or yeast. The term “dormant” in relation to microorganisms includes, but is not limited to, spores that are activated upon exposure to appropriate conditions. The present invention uses probiotic organisms to reduce malodours associated with animal litter that has been soiled by urine and/or faeces. Accordingly, as used herein, the term “probiotic organisms” is simply used to refer to non-harmful and/or beneficial microorganisms, such as, but not limited to bacteria and/or yeasts. Further, a “probiotic formulation” of the present invention is a formulation comprising one or more probiotic organisms.

The use of bacteria and/or yeast to reduce malodours is counter-intuitive to conventional thinking since it is bacteria (and other microorganisms) that are generally responsible for many of the malodours associated with urine and faeces. However, the Applicant has advantageously determined that a probiotic formulation is able to impart a malodour-inhibiting property to the absorbent material used as animal litter. Without being bound by theory, it is believed that the probiotic organisms: i) capture and degrade malodour-causing compounds before they cause excessive malodour; and/or degrade the substrates upon which malodour-causing bacteria would normally grow.

Malodours are typically caused by the presence of high levels of various compounds, including, but not limited to: ammonia-containing and sulphur-containing compounds and gases, including, but not limited to 3-mercapto-3-methylbutan-1-ol and hydrogen sulphide. These compounds may be broken down by the probiotic organisms.

This process changes the underlying microbial ecology of the treated area to being one that is balanced, healthy and one which controls the re-emergence of malodours as well as the re-emergence of malodour-causing bacteria.

Preferably, the probiotic formulation comprises non-pathogenic, heterotrophic microorganisms. Non-pathogenic organisms do not cause disease and are of minimal potential hazard to the environment. The species used are preferably isolates of naturally occurring organisms and are not genetically engineered or modified. Heterotrophs are organisms that require organic compounds as their carbon/nutrient source. The preferred species are those that use the carbon sources in pet. urine and faeces for growth. Organisms in the probiotic formulation may be active cells or cells in an inactive/dormant form. Autotrophic organisms may also be applied which use inorganic substrates, such as ammonia, for energy.

In certain embodiments, the probiotic formulations may comprise yeasts, Actinobacteria, Firmicutes and Gram negative bacteria. The preferred yeast is the common budding yeast, Saccharomyces cerevisiae. This yeast, under the name S. boulardii has been used previously as a probiotic to treat diarrhoea caused by bacteria. S. cerevisiae has also been shown to survive in the gastrointestinal tract while eliminating the potentially pathogenic bacteria residing therein; however, it does not colonize the gastrointestinal tract.

Preferred species of Firmicutes include Bacillus and Lactobacillus species. Lactobacillus casei is among the best-documented probiotics and has been extensively studied. This bacterium finds many applications in the food and diary industries. In addition, L. casei has been combined with other probiotic strains of bacteria in randomized trials to study its effects in preventing antibiotic associated diarrhoea and Clostridium difficile infections. Other preferred species of Firmicutes include B. subtilis, B. coagulans B. cereus and L. plantarum including spores of those species that produce spores.

Preferred Proteobacteria include Rhodopseudomonas palustris; which is a Gram negative, photosynthetic, non-sulphur purple bacteria. Like a number of other probiotic organisms, it is metabolically versatile by virtue of its ability to grow under both aerobic and anaerobic conditions. In the presence of oxygen, R. palustris generates energy by degrading a variety of carbon-containing compounds including sugars, lignin monomers, polymers and methanol. Another preferred Proteobacteria is Rhodobacter sphaeroides.

Preferred Actinobacteria come from the genus Streptomyces. Preferred species include, but are not limited to, S. albus and S. griseus. These bacteria may produce an antibiotic compound that may help to prevent the growth of malodour-causing bacteria.

In further embodiments, the probiotic formulation may comprise yeast, Actinobacteria, Firmicutes, Proteobacteria and Chloroflexi. Genera that are useful in the present invention include, but are not limited to: Bacillus Bifidobacterium, Lactobacillus, Lactococcus, Proteus, Pseudomonas, Rhodobacter, Rhodopseudomonas, Sacchromyces, Streptococcus and Streptomyces.

The probiotic formulations for use in the present invention may include any one or more type or species of microorganism, including, but not limited to, spores from more than one species of Bacillus.

In addition to microorganisms, purified enzymes may be included in the animal litter of the present invention. In certain embodiments of the present invention, the enzymes may be included in the probiotic formulation. Enzymes are substrate-specific and fast-acting. In enzymatic reactions, the malodourous compounds are converted into non-odourous compounds. Examples of potentially beneficial enzymes include uricases, ureases and proteases.

Metal ions may also be included in the animal litter of the present invention, to inhibit odour formation. For example, gold, silver and/or copper ions may be added, these can bind to and neutralise pheromones, such as felinine, which generate malodours. Again, these metal ions may be included in the probiotic formulation to simplify its incorporation into the animal litter.

In certain embodiments of the present invention, a surfactant/wetting agent may be included in the probiotic formulation. The surfactant/wetting agent may be used to assist the application process and the adherence of microbes to the absorbent mineral material. Possible agents include, but are not limited to, sodium xylenesulfonate or sodium lauryl ether sulphate.

The probiotic formulation for use in the present invention is typically prepared as a liquid formulation with an aqueous basis. The liquid carrier for the probiotics may include any one or more of the components mentioned above together with a buffer to keep the microorganisms under conditions whereby they remain viable. Typically, the liquid carrier will be buffered to approximately pH 6. The liquid carrier may also include a carbon source for the microorganisms once they begin to grow or come out of dormancy. In one embodiment, it is envisaged that molasses may be used as the carbon source.

Application of the probiotic formulation to the at least one absorbent mineral material may be done by any method known in the art. Typically, application will be achieved by a spray methodology. The spray may include a dried probiotic formulation such as a powder, or a wet probiotic formulation such as a mist. In both cases, it is preferable to allow the absorbent mineral material to cool slightly after being processed at high temperature, to prevent damage to the microbial organisms. It is however, preferable to apply the probiotic formulation as soon as practicable after the absorbent mineral material has been processed since, for example, perlite and vermiculite expand considerably during their exfoliation/expansion but then relax and shrink slightly as they cool. In order to allow best access to the many pores and/or voids present in the absorbent mineral material, it is therefore preferable to apply the probiotic formulation while the absorbent mineral material is in its most expanded state.

The probiotic formulation may be added to the vermiculite, perlite, or mixture thereof, after the screening phase, but before the product is bagged. Preferably, the probiotic formulation is sprayed onto the vermiculite/perlite. The treated vermiculite/perlite is then available to be bagged before sale. Typically, the treated vermiculite/perlite animal litter is prepared in bag sizes of 8L, 18L, 27L and 40L.

As noted above, it is envisaged that the odour control animal litter of the present invention may be formed as pellets and/or agglomerates. Treatment of the pellets and/or agglomerates with the probiotic formulation may be carried out at any time, either before, during or after pellet/agglomerate formation. In the case of treatment during pellet/agglomerate formation, the probiotic formulation may be combined with the adhesive solution or may be added separately to the mixture.

In some embodiments of the present invention, a malodour-masking agent may also be added to the litter. Masking agents may include fragrances that are pleasant to humans. It should be noted that some fragrances, even at low concentrations, might discourage animals from using the treated litter. Accordingly, the concentration and identity of any masking agent must be carefully selected.

Yet another difficulty associated with current animal litters is the disposal thereof. Many users are loath to subject their gardens or landfill sites to the application of soiled animal litter for a number of reasons, including its malodour. The animal litter of the present invention may be used as a carrier of fertilizer or may be simply mixed with soil as a conditioning agent. The mineral material that is the basis of the litter is a naturally occurring product that can be used to introduce air into the soil as well as provide reservoirs for water storage. The animal urine and/or faeces in soiled litter may function as a fertilizer through the synergistic actions of the probiotic organisms with soil organisms. This application of the soiled litter is applicable to domestic gardens as well as to landfill sites where the soiled litter can also produce similar beneficial effects.

The odour-controller of the present invention may also be used in, or as, bedding material for small animals and pets, such as, but not limited to: guinea pigs, mice, rats, reptiles, and birds.

One of ordinary skill in the art will appreciate that materials and methods, other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by examples, preferred embodiments and optional features, modification and variation of the concepts herein disclosed may be resorted to by those skilled in the art, and that such modifications and variations are considered to be within the scope of this invention as defined by the appended claims.

The present invention is not to be limited in scope by the specific embodiments and Examples described herein, which are intended as single illustrations of individual aspects of the invention, and functionally equivalent methods and components are within the scope of the invention. Indeed, various modifications of the invention, in addition to those shown and described herein will become apparent to those skilled in the art from the foregoing description and accompanying Example. Such modifications are intended to fall within the scope of the present invention. Indeed, the use of the odour controller to line refuse containers used by households to dispose of household rubbish or in rubbish bins used in public places, is also contemplated as falling within the scope of the present invention.

### EXAMPLE

### Preparation of Probiotic-Treated Vermiculite and/or Perlite Vermiculite

Vermiculite ore was graded prior to its use. In this exemplary embodiment, Grade 4/Large Grade vermiculite ore was used. The ore was exfoliated using standard procedures. For example, the ore was loaded into a furnace via a conveyor; it then travelled through the furnace by vacuum and gravity. The ore was heated to a temperature of 500-750° C., at which point, water trapped in each ore-particle evaporated and caused the particle to “exfoliate”. The exfoliated vermiculite was then screened to remove any additional small particles that were not previously removed from the ore.

### Perlite

Perlite ore was graded prior to its use. In this exemplary embodiment, Coarse perlite ore was used. The ore was expanded using standard procedures. For example, after the ore was loaded into a furnace via a conveyor, it then travelled through the furnace by vacuum and gravity. The ore was heated to a temperature of 800-1100° C., at which point, water trapped in each ore-particle evaporated and caused the particle to “expand”. The expanded perlite was then screened to remove any additional small particles that were not previously removed from the ore.

### Probiotic

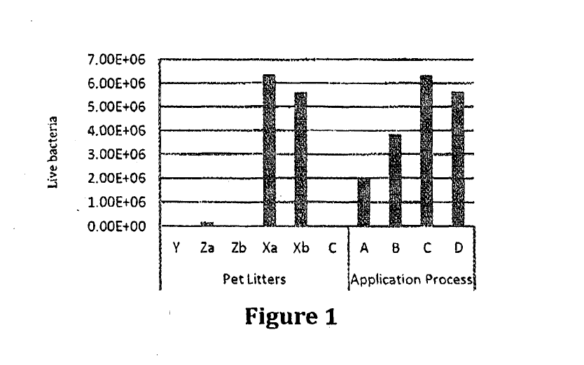

Many of the probiotics currently available claim to reduce malodours associated with, inter alia, pet urine. Twelve probiotics were reviewed and one product (X) stood out for its scientific basis, extended shelf-life, proven record and absence of fragrance. Trials had begun with another product (Y), and it together with product X were selected as the subjects for further investigations. The probiotics were applied at different concentrations and at various stages of vermiculite manufacturing to ensure that the application procedure is efficient and effective. The effectiveness has been determined by establishing total numbers of active bacteria for each probiotic and its application process (FIG. 1). Product X has higher numbers of viable cells and it has been confirmed that the active ingredients of product X (Bacillus spores) are not activated (germinated) during application in a hot furnace (˜60° C.). It was shown that transporting and storing the pet litter for an extended period of time had no adverse effect. After transportation and three months storage, the probiotic was still found to be effective. Further investigations are ongoing to determine the extended shelf-life of the probiotic after application to vermiculite.

The ability to control malodours will set this product apart from its competitors. To test product X against other probiotics and competitor pet litters (Z), trials have been conducted using a synthetic cat urine based on the reference values for feline urine (Table 2).

TABLE 2
Composition of feline urine (%)

| Component | % |
|---|---|
| ammonia | 0.05 |
| sulphate | 0.18 |
| phosphate | 0.12 |
| chloride | 0.6 |
| sodium | 0.1 |
| creatinine | 0.1 |
| uric acid | 0.003 |
| urea | 2.0 |
| water | 95 |

The average adult cat uses its kitty litter tray 5 times per day, producing 20-44 mL/kg of urine and faeces per day. The average cat also weighs between 4 and 5 kilos. Therefore, 200 mL per day of the artificial urine was applied to a standard sized litter tray. The most commonly reported odour for pet litters is ammonia due to the breakdown of urea, which is closely associated with pH. While the pH remained below approximately 7, very little ammonia was detectable. Therefore, products were assessed microbiologically using plate counts, microscopy and enzyme activity, and chemically for and Nitrogen values. It was found that after 14 days, the product X-treated vermiculite had a pH 1 to 1.5 units lower than untreated vermiculite and a compressed paper-style litter.

The application of product X to vermiculite was the most effective probiotic. It was faster-acting with longer-lasting odour control than product Y and competitor pet litter Z. The probiotic-treated vermiculite effectively controlled ammonia odours produced from the synthetic cat urine for the duration of the trials (2 weeks) where others failed.

Product X is a commercially available, concentrated probiotic formulation (Freshen™ Free, Novozymes A/S, Denmark). This formulation is sold as a 10× concentrate and contains the following components at the indicated concentrations:

TABLE 3
Composition of Freshen ™ Free liquid carrier (%)

| Component | % |
|---|---|
| sodium xylene sulfonate | 10-20 |
| citric acid | 5-10 |
| alcohols, c12-14, ethoxylated | 1-5 |
| sodium nitrate | 1-5 |
| disodium laureth sulfosuccinate | 1-5 |
| amine oxide | 1-5 |
| 1,2-benzisothiazolin-3-one | <0.5 |
| 5-chloro-2-methyl-4-isothiazolin-3-one/ | <0.5 |
| 2-methyl4-isothiazolin-3-one | |

The concentrated probiotic formulation further comprises a mixture of several bacteria as mentioned above.

Where the terms “comprise”, comprises”, “comprising”, “include”, “includes”, “included” or “including” are used in this specification, they are to be interpreted as specifying the presence of the stated features, integers, steps or components referred to, but not to preclude the presence or addition of one or more other feature, integer, step, component or group thereof.

Further, any prior art reference or statement provided in the specification is not to be taken as an admission that such art constitutes, or is to be understood as constituting, part of the common general knowledge.

1. An odour controller comprising at least one absorbent mineral material and a microbiota that facilitates malodour-control.

2. The odour controller of claim 1, wherein the absorbent mineral material is expanded perlite and/or exfoliated vermiculite.

3. The odour controller of claim 1 or claim 2, wherein the microbiota comprises a probiotic formulation.

4. The odour controller of claim 3 comprising exfoliated vermiculite treated with a probiotic formulation.

5. The odour controller of claim 3 comprising expanded perlite treated with a probiotic formulation.

6. The odour controller of any one of claims 3 to 5, wherein the probiotic formulation comprises non-pathogenic, heterotrophic microorganisms and/or non-pathogenic, autotrophic microorganisms.

7. The odour controller of claim 6, wherein the microorganisms are non-genetically modified microorganisms.

8. An odour-control animal litter comprising the odour controller of any one of claims 1 to 7.

9. A method for producing an odour controller, the method including the steps of:
i. heating an industrial mineral to produce an absorbent mineral material; and
ii. applying thereto a microbiota that facilitates malodour-control to the absorbent mineral material;
whereby the absorbent mineral material and the microbiota comprise the odour controller.

10. The method of claim 9, further including the step of pelletising or agglomerating the industrial mineral material to form individual pellets or agglomerates.

11. The method of claim 9 or 10, wherein the industrial mineral material is perlite, vermiculite or a mixture thereof.

12. The method of any one of claims 9 to 11, wherein the microbiota comprises a probiotic formulation.

13. The method of claim 12, wherein the probiotic formulation comprises non-pathogenic, heterotrophic microorganisms and/or non-pathogenic, autotrophic microorganisms.

14. An odour controller produced according to the method of any one of claims 9 to 13.

15. The odour controller of claim 14, wherein the odour controller is an odour-control animal litter comprising exfoliated vermiculite treated with a probiotic formulation.
